(19) United States
(12) Patent Application Publication
(10) Pub. No.: US 2008/0304160 A1
(43) Pub. Date: Dec. 11, 2008

(54) Variable Focus Lens Package

(75) Inventors: Bernardus Hendrikus Wilhelmus Hendriks, Eindhoven (NL); Emile Johannes Karel Verstegen, Eindhoven (NL); Stein Kuiper, Eindhoven (NL); Marco Van As, Eindhoven (NL); Edwin Maria Wolterink, Eindhoven (NL)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONIC, N.V., EINDHOVEN (NL)

(21) Appl. No.: 10/597,428

(22) PCT Filed: Jan. 20, 2005
(86) PCT No.: PCT/IB2005/050235

§ 371 Date: Aug. 29, 2008

(30) Foreign Application Priority Data
Jan. 30, 2004 (EP) 04100351.8
May 24, 2004 (EP) 04102253.4

(51) Int. Cl. G02B 3/14

(52) U.S. Cl. 359/666

(57) ABSTRACT

Proposed is a variable focus lens package (2) including lens (31, 75) as covers, which covers are provided as moulded replica layers (31, 75) on a substrate (30, 74) and are provided with integral alignment means (33, 77).

The invention relates to a variable focus lens package comprising a plurality of optical elements in a light path, which plurality of optical elements comprises:

a fluid optical element in a fluid chamber comprising a first fluid and a second fluid, which are non-miscible, and which are in contact over a meniscus, wherein a shape of the meniscus is variable under the application of a voltage to an electrically conducting surface of the fluid chamber, said fluid chamber being surrounded by an encapsulation;

a non-fluid optical component that is part of the encapsulation of the fluid chamber,

of which fluid optical element and which non-fluid optical element at least one is a lens.

The invention also relates to a method of manufacturing such a variable focus lens package.

Such a variable focus lens package is for instance known from WO-A 2003/0693080. The known lens package comprises a fluid lens of the electrowetting type and a first and a second conventional non-fluid lenses at opposite sides of the fluid lens. The first fluid is an electrically insulating fluid and the second fluid is an electrically conducting fluid, but could alternatively be a polar fluid. The first lens is a convex-convex lens of highly refracting plastic, and having a positive power. At least one of the surfaces of the first lens is aspherical, to provide desired initial focusing characteristics. The second lens is formed of a low dispersive plastic, and includes an aspherical lens surface which acts as a field flattener. The first lens is formed as a single body with a cylindrical tube that forms part of the encapsulation of the fluid chamber. The second lens may extend beyond the encapsulation of the fluid chamber.

It is a disadvantage of the lens package, that its assembly to further lenses and/or its integration with an image sensor is difficult. This assembly needs to be carried out with a holder that holds the lens package and any further lenses at any side faces. Nonetheless, electrical connections need to be provided at least one of the side faces in order to supply the voltage to the fluid lens. Moreover, the one or more lenses and the image sensor need to be aligned properly in order to have a proper optical quality.

It is therefore a first object of the invention to provide an variable focus package of the kind mentioned in the opening paragraph, that can be assembled more easily. It is a second object of the invention to provide a method of the kind mentioned in the opening paragraphs that reduces the amount of tolerance in the manufacture and hence improves the lens quality.

The first object is achieved in that the non-fluid optical component is constructed from a substrate that comprises a transparent portion in the light path, and from a moulded surface layer that is present at a side of the substrate facing away from the fluid optical element and further comprises alignment means for alignment of the lens package with further lenses.

The second object is achieved in that in a plurality of such packages are made simultaneously with the steps of (1) assembling a carrier comprising a plurality of cavities filled with at least one of said fluids to a substrate with transparent portions for each of the light paths, which substrate has a moulded surface layer that includes the non-fluid lens and alignment means for alignment with further lenses, and (2) separating said plurality of lenses into individual variable focus lenses.

The moulded surface layer of the invention allows the integration of lens functionality and alignment features. The integration of alignment features in the moulded surface layer allow that they are defined in the mould. Hence, they are defined in a standardized manner, which is independent of the position of side faces. Therewith, the alignment—at least with other optical components—is made independent of the actual separation process.

The alignment features are here present at the bottom and/or top side of the lens package. It is therewith possible to make a stack of lenses in a desired manner. As a consequence of the proper alignment, it will be easier than in the prior art device to make such a stack. Therewith, the variable focus lens can be held relatively simple and standardized. At the same time, the stacking of various lenses to arrive at a zoom lens is helped. The use of a moulding process furthermore allows that the alignment features are defined with any desired and specified height. The height of the alignment feature can be different from that of the lens. This height definition allows a positioning of the lens not only laterally, but also a positioning at a specified distance to other lenses.

It is preferred with respect to the alignment features, that they are defined at both sides of the lens, or as a ring-shaped feature. This reduces the risk of undesired optical effects as a consequence of “out of plane” assembly. In such out of plane assembly there is an angle between the lens axes that is unequal to zero degrees.

Moreover, the assembly can be carried out with plates instead of with individual lenses having non-planar surfaces. This reduces the amount of assembly, and it will minimize tolerances in the alignment within the lens. Another advantageous feature of the invention is the reduction of the total height of the package.

Lenses that are defined with moulding techniques are known per se, such as from the U.S. Pat. Nos. 4,615,847 and 4,890,905. However, these patents disclose the manufacture of standard lenses only. In the invention, the moulding technique is used to provide both lens functionality and alignment functionality, which has furthermore the benefit of providing a standardized mechanical interface of the electrowetting lens. Moreover, since the electrowetting lens comprises a single meniscus, there is no need to provide a non-fluid lens with two curved surfaces. One moulded surface layer on a substrate is thus principally sufficient.

Furthermore, the non-fluid optical component is particularly a lens, or a lens surface. Alternatively, however, it may be a diaphragm, a grating or the like. A preferred lens shape is aspherical to provide desired initial focussing characteristics. The replica technique applied in the invention allows the provision of structures up to some millimetres thickness, of which very strong lenses can be made.

The non-fluid optical component obtained with the replica technique may contain dyes or other chemical compound. This leads to a system with additional functionality. The dye is for instance a photochromic compound, such as that obtainable as MXP7-114 from PPG Industries. The transparency of the optical component is dependent on the light intensity. If the light intensity is very high, the transparency will be relatively low. As a consequence, the intensity of the light arriving at the image sensor is relatively constant. Images can be obtained without loss of optical quality.

Another dye that may be added to the non-fluid optical component is an electrochromic compound. Herewith, the transparency can be set with a help of a voltage. This is allowable, as there is no other voltage applied to the non-fluid optical component, except in the embodiment below. As the non-fluid optical component is in fact a pattern in the replica layer, this pattern can be chosen to desire. Hence, ring-shaped structures of varying height and negative lenses can be made. Such structures can be applied advantageously as diaphragms. Another possibility is a structure that extends on the complete surface. This can be used as a shutter.

In a preferred embodiment, the substrate including a first and a second portion that are mutually connected through a expandable joint. The expandable joint is preferably a ring-shaped membrane with a non-planar surface. The inclusion of such a membrane in the substrate can be suitably combined with the provision of moulded surface layers on the glass. In fact, the moulded surface layer can be provided on the substrate before the membrane and the provision of an aperture in the substrate at the location of the membrane. The use of such a expandable joint is found to be very effective to cope with the volume expansion of the fluid as a function of the temperature, and to ensure a complete filling of the package.

Preferably, the non-fluid optical element is part of an encapsulation defining the fluid chamber. However, in another embodiment, a further chamber is provided between the fluid focus optical element and the non-fluid focus optical element. Such a chamber may contain lenses that are provided on a substrate with replica technique. The replica layer will then further contain a spacer that acts as a side wall of the chamber.

In again another embodiment the moulded surface layer comprises a liquid crystalline material. Therewith a further variable focus optical element is provided in the package. A single liquid crystalline optical element would introduce a dependence on the polarisation. This does not appear to be advantageous for lenses in camera modules, but is very interesting for special applications such as that of optical recording. Liquid crystalline elements can be stacked however, in which case there is a chamber present. Liquid crystalline lenses are Fresnel lenses in particular and known per se from U.S. Pat. No. 6,449,236. Liquid crystalline lenses made with replica technique are described in the non-prepublished patent application EP 04100449.0 (PHNL040107), which is included herein by reference.

In a preferred modification hereof, the liquid crystalline optical element acts as a lens and the fluid focus optical element acts as a variable diaphragm. The advantage of the application of the fluid focus element as a diaphragm is that it can be tuned continuously. The advantage of the application of the liquid crystalline element as a lens, in comparison to the reversed solution, is that the driving voltage of such a lens is substantially lower than that of a fluid focus lens.

It is preferred that the variable focus lens package comprises non-fluid optical components at opposite sides of the fluid focus lens. At least one of those optical components is a lens or has lens functionality by preference.

It is furthermore preferred that alignment means for alignment within the variable focus package are present as well. Mechanical alignment means are preferred, although optical alignment means can be alternatively used. The latter is particularly the case if the package is assembled on a wafer-scale. Suitable examples of mechanical alignment means include locking features, such as protrusions and corresponding cavities.

In another suitable embodiment, a moulded layer of a cross-linked polymer material with a lens function is present at an inner side of the encapsulation of the fluid chamber. It was found by the inventors that cross-linking of the polymer improves the lifetime of the moulded layer against the fluids of the fluid focus lens. Particularly critical is herein the organic fluid, that is particularly a fluid of an apolar or nonpolar organic material.

The presence of a lens within the chamber is particularly advantage, in that herewith the use of a separate grating structure can be dispensed with.

These and other aspects of the invention will be further elucidated with reference to the figures, in which:

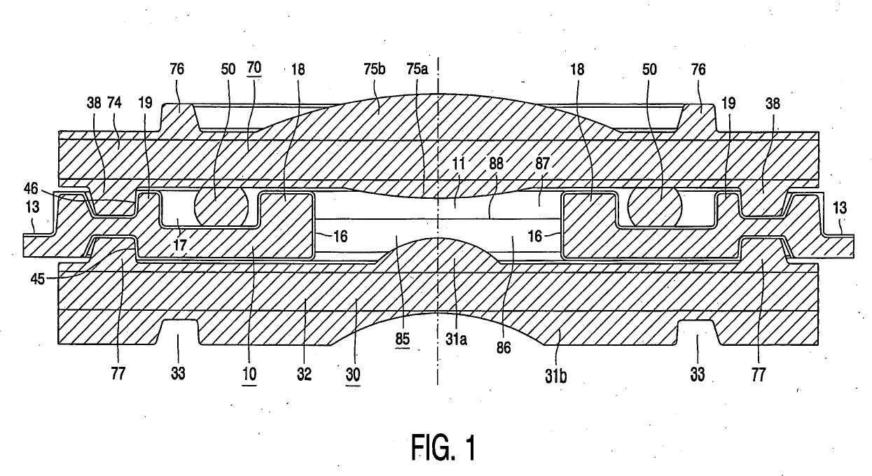

FIG. 1 is a diagrammatic cross-sectional view of the lens of the invention;

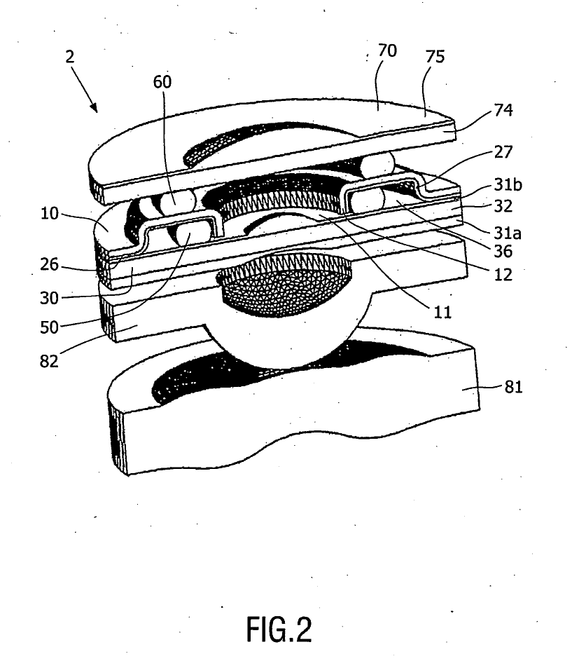

FIG. 2 is an diagrammatic, exploded view of the lens.

FIG. 1 diagrammatically shows a variable focus lens package 2 according to a preferred embodiment of the present invention.

The variable focus lens package 2 comprises a plastic annular body 10, which is at least partially covered by a layer comprising electrically conducting material, such as metal. The electrically conducting layer is covered by a layer comprising an electrically insulating material, such as parylene, whereas the electrically insulating layer is covered by a layer comprising a hydrophobic material. The three layers covering a portion of the body 10 are diagrammatically depicted in FIG. 1 by means of a line, which is indicated by reference numeral 16.

The body 10 of the variable focus lens package 2 comprises—bevelling—surfaces 13 which are located at an outer portion. Furthermore, at a bottom side, the body 10 is provided with an annular groove 17.

A through-hole 11 of the body 10 is closed off by means of a bottom lens member 30 which is located at the bottom side of the body 10 and a top lens member 70 which is located at the top side of the body 10. Both lens members 30, 70 are formed as so-called replica lenses. Such lenses comprise a glass base plate 32, 74 and a plastic lens bodies 31a. 31b, 75a, 75b, and are manufactured with a replica technique, with the use of a mould for moulding the plastic and UV-light for curing the plastic inside the mould, thus effecting cross-linking. Preferably the cross-linking density is at least 0.05 and preferably in the order of 0.08-0.15. The outer lens bodies 31b, 75b comprise alignment means 33, 76. These alignment means 33,76 are designed here to have an annular shape, but this is not necessary. In this example, the alignment means have the same height as the lens parts 75b, 31b, but that is by no means necessary; the moulding technique allows height variations as desired.

The variable focus lens package 2 comprises a sealing ring 50 for sealing a fluid chamber 85 which is delimited by the body 10, a bottom surface of the top lens member 70 and a top surface of the bottom lens member 30. The sealing ring 50 is located between protruding annular portions 18, 19 of the body 10 and the base plate 74 of the top lens member 70. The design of the lens may be amended so as to include more than one sealing ring, if so desired.

According to an important aspect of the present invention, at both the top surface 36 of the bottom lens member 30 and the bottom surface 76 of the top lens member 70, a positioning ring 38, 77 is arranged on the lens members 30, 70. The positioning rings 38, 77 play a role in aligning the lens members 30, 70 with respect to each other and with respect to the through-hole 11 of the body 10. On the one hand, an outer diameter of a bottom positioning ring 38 is chosen such that when the bottom lens member 30 is put in place with respect to the body 10, an outer circumference of the bottom positioning ring 38 contacts an outer wall 45 of the body 10, without the presence of play. In this way, a central axis of the lens body 31 of the bottom lens member 30 is exactly aligned with a central axis of the through-hole 11 of the body 10. On the other hand, an outer diameter of a top positioning ring 77 is chosen such that when the top lens member 70 is put in place with respect to the body 10, an outer circumference of the top positioning ring 77 contacts the upright wall 46, without the presence of play. In this way, a central axis of the lens body 75 of the top lens member 70 is exactly aligned with the central axis of the through-hole 11 of the body 10, and consequently also with the central axis of the lens body 31 of the bottom lens member 30.

For the purpose of fixing the various lens package elements 10, 30, 50, 60, 70, with respect to each other, clamping units can be used, which are however not depicted. A clamping unit is for instance arranged such as to clamp the top lens member 70 against the body 10, wherein the sealing ring 50 is clamped between the top lens member 70 and the body 10.

The variable focus lens package 2 comprises a quantity of water 86 and a quantity of oil 87. The water 86 and the oil 87 are present in the fluid chamber 85, wherein the water 86 is situated at a bottom side of the fluid chamber 85, and wherein the oil 87 is situated at a top side of the fluid chamber 85. The water 86 and the oil 87 are separated by a meniscus 88. The shape of this meniscus 88 is variable under the influence of a voltage between the electrically conducting layer of the body 10 and the water 86, as the wettability of the hydrophobic layer with respect to the water is variable under the application of a voltage.

FIG. 2 diagrammatically shows an exploded view of a second embodiment of the variable focus lens package 2. The bottom lens member 30 comprises a replica lens having three layers. The replica lens comprises a glass base plate 32, which is sandwiched between a plastic bottom lens layer 31a of which a central portion constitutes a concave lens body, and a plastic top lens layer 31b of which a central portion constitutes a convex lens body. Further, in the shown example, the top lens member 70 also comprises a replica lens. This replica lens of the top lens member 70 comprises a glass base plate 74 and a plastic top lens layer 75 of which a central portion constitutes a convex lens body. It is observed that the replica lenses 31a, 31b at opposing sides of the glass plate 31 need not to have the same composition. A diacrylate layer is suitable for the layer 31a and a HDDA replica is suitable for the layer 31b. The lenses are provided at the side of layer 31b with coatings, such as anti-reflection coatings and UV-absorption coatings in a sputtering treatment. Suitable anti-reflection coatings comprise titanium oxide , silicon oxide and/or tantalum oxide.

An important feature of the lens package 2 is that the body 10 itself may be used as an electrical connector of the lens package 2, wherein it is not necessary that an additional element for contacting the body 10 is applied. In order to avoid short-circuiting between the body 10 and the layer 37 of the bottom lens member 30, a bottom surface 26 of the body 10 is covered by an electrically insulating layer 27, at least at the areas where the body 10 rests on the bottom lens member 30. The shown body 10 is designed such as not to contact the top surface 36 of the bottom lens member 30 at an end of an inner portion 12 of the body 10.

The body 10 may comprise clamping arms (not shown in FIG. 2) for fixing the bottom lens member 30. However, it is also possible that clamping means for clamping the bottom lens member 30 against the body 10 are provided, which are not formed as an integral part of the body 10. The top lens member 70 may be fixed with respect to the body 10 in any suitable way, for example also by means of clamping means.

Besides the connector which is constituted by the body 10, the fourth variable focus lens package 2 needs to comprise another connector (not shown in FIG. 2), which is in contact with the electrically conducting layer 37 of the bottom lens member 30, in order to be in contact with the water through this layer 37. This connector may be shaped and arranged in any suitable way, wherein it is important that the connector does not contact the body 10.

The variable focus lens packages 2 may be applied in hand-held apparatus, such as mobile phones and optical scanning devices for use in digital recording equipment A number of lens packages 2 may be positioned in a row, wherein the through-holes 11 of the lens packages 2 are aligned with respect to each other, in order to create a zoom lens. Although the lens package 2 is shown to have lens parts at both sides of the glass plate 30, there is no need, and it is sufficient that these are provided at the outside only. The lens packages 2 according to the present invention are particularly intended for application in a camera, which further comprises an image sensor and an interconnecting body, wherein the interconnecting body comprises electrically conductive tracks arranged on a first surface and a second surface of the interconnecting body, and wherein the electrically conductive tracks are shaped such as to be able to establish a connection between both the image sensor and the variable focus lens package 2 to driver electronics therefore, or to contact pads. The camera may be part of the above-mentioned hand-held apparatus, which may further comprise input means, information processing means and display means.

1. Variable focus lens package (1, 2, 3) comprising a plurality of optical elements in a light path, which plurality of optical elements comprises:
a fluid optical element in a fluid chamber comprising a first fluid (87) and a second fluid (86), which are non-miscible, and which are in contact over a meniscus (88), wherein a shape of the meniscus (88) is variable under the application of a voltage to an electrically conducting surface of the fluid chamber;
a non-fluid optical component,
of which fluid optical element and which non-fluid optical element at least one is a lens,
wherein the non-fluid optical component is constructed from a substrate that comprises a transparent portion in the light path, and from a moulded surface layer that is present at a side of the substrate facing away from the fluid optical element and further comprises alignment means for alignment of the lens package with further lenses.

2. A variable focus lens package as claimed in claim 1, characterized in that a second non-fluid optical component is present in the light path in addition to the—first—non-fluid optical component, such that the fluid lens is sandwiched between the first and the second non-fluid optical component, which second non-fluid optical component is constructed from a substrate that comprises a transparent portion in the light path, and a moulded surface layer that is present at an outside of the encapsulation and further comprises alignment means for alignment of the lens package with further lenses.

3. A variable focus lens package as claimed in claim 1, wherein the substrate and a further carrier forming part of the encapsulation comprise alignment means for mutual alignment.

4. A variable focus lens package as claimed in claim 1, wherein the alignment means comprise a ring-shaped protrusion or cavity circumfering the light path.

5. A variable focus lens package as claimed in claim 1, further comprising a moulded layer of a cross-linked polymer material with a lens function at an inner side of the encapsulation of the fluid chamber.

6. A variable focus lens package as claimed in claim 5, wherein said lens function at the inner side of the encapsulation functions as a grating.

7. A variable focus lens package as claimed in claim 1, wherein said non-fluid optical component is an aspheric lens.

8. An assembly of a variable focus lens package according to claim 1 and a further lens,
wherein the variable focus lens and the further lens are aligned to each other with the alignment means present in the moulded surface layer of the variable focus lens.

9. A camera module comprising an image sensor, a driver and a variable focus lens package according to claim 1.

10. An imaging apparatus provided with a variable focus lens package according to claim 1.

11. A method of manufacturing a variable focus lens package comprising a plurality of optical elements in a light path, which plurality of elements comprises:
a fluid optical element in a fluid chamber comprising a first fluid (87) and a second fluid (86), which are non-miscible, and which are in contact over a meniscus (88), wherein a shape of the meniscus (88) is variable under the application of a voltage to an electrically conducting surface of the fluid chamber;
a non-fluid optical element,
of which fluid and non-fluid optical element at least one is a lens,
in which method a plurality of such packages are made simultaneously with the steps of:
assembling a carrier comprising a plurality of cavities filled with at least one of said fluids to a substrate with transparent portions for each of the light paths, which substrate has a moulded surface layer that includes the non-fluid lens and alignment means for alignment with further lenses, and
separating said plurality of lenses into individual variable focus lenses packages.
